(19) United States
(12) Patent Application Publication
(10) Pub. No.: US 2024/0166846 A1
(43) Pub. Date: May 23, 2024

(54) MARINE REPAIR COMPOSITION

(71) Applicant: Illinois Tool Works Inc., Glenview, IL (US)

(72) Inventors: Duy Thach Tran, Glenview, IL (US); Mehdi Habibpour, Glenview, IL (US); Rick Turpin, Glenview, IL (US); Carlton Seaboldt, Glenview, IL (US); Grant Shouldice, Glenview, IL (US)

(73) Assignee: Illinois Tool Works Inc., Glenview, IL (US)

(21) Appl. No.: 18/387,887

(22) Filed: Nov. 8, 2023

Related U.S. Application Data
(60) Provisional application No. 63/426,420, filed on Nov. 18, 2022.

(51) Int. Cl. C08K 5/053; C08K 3/26; C08K 3/34; C08K 5/14; C08K 5/18; C08K 7/16

(52) U.S. Cl. CPC C08K 5/053; C08K 3/26; C08K 3/34; C08K 5/14; C08K 5/18; C08K 7/16; C08K 2003/265

(57) ABSTRACT

A process for repairing a marine surface is provided that includes the mixing of the part A and the part B until a terminal color change occurs within ±5 minutes of cure. The mixture is applied to a substrate of the marine surface in need of repair to a thickness of up to 6.35 mm. The cured mass has water absorption less than of 0.2% in freshwater or 0.15% in ocean water salinity. A marine repair composition is provided that includes in a part A: an unsaturated vinyl ester resin, a reactive diluent, a cure promoter, a cure inhibitor, a corrosion inhibitor and a filler. The part B includes a free-radical cure initiator stored separately from the part A until mixed with the part A to form the composition.

### RELATED APPLICATIONS

This application is a non-provisional application that claims priority benefit of U.S. Provisional Application Ser. No. 63/426,420 filed Nov. 18, 2022; the contents of which are hereby incorporated by reference.

### FIELD OF THE INVENTION

The present invention in general relates to a marine repair composition and in particular, to such a composition that provides improved cured mass properties in a marine environment.

### BACKGROUND OF THE INVENTION

Fiberglass and metal marine hulls are susceptible to corrosion and other damage by way of collision, wave action, ice, or corrosion. Body fillers are used to repair such damage. Body fillers are known synonymously in the art as body putty.

Curing of thick marine fillers is a long process compared to a like thickness of an automotive filler. In some of the prior art, to cure thick marine fillers requires double the amount of time to achieve a sandable hardness relative to an automotive counterpart. Such marine fillers are exposed to greater operational forces than an automotive counterpart, especially when regions of repair are below the waterline. Attributes of water that include corrosiveness, impact forces, drag, and infiltration lead to marine filler compositions that favor cured composition properties relative to ease of use and differentiate these compositions from those used in the automotive setting.

As a result, many prior art marine fillers have a working time that is shorter than would otherwise be desirable. Furthermore, additional time is wasted in a repair waiting for complete cure as attempts to sand these before properly cured can ruin the attempted repair requiring additional effort.

Owing to the drag on marine surfaces below the waterline, high-quality surface finishes are required, such a surface layer is subjected to filling, sanding, trimming, and priming prior to receiving a paint coating that imparts a low drag and high gloss finish. Obtaining a smooth surface free of surface defects is important prior to painting, given that any surface defects present on the vehicle body surface tend to be amplified once paint is applied. A limiting factor in conventional application of body marine fillers is slow cure. The cure rates in conventional compositions cannot be further increased due to the fact that increasing the rate of the reactions would result further shortened working time.

Thus, there exists a need for a marine body filler composition that cures more rapidly than conventional compositions. There further exists a need for a marine body filler composition that has colorimetric change when the composition is cured and amenable to sanding to eliminate excess waiting time to assure cure to hardness.

### SUMMARY OF THE INVENTION

A process for repairing a marine surface is provided that includes mixing a vinyl ester resin formulation part A including a curable unsaturated vinyl ester resin, a monomer reactive diluent in which said curable resin is dissolved or suspended, and at least one color changing dye adapted to change color upon mixing of the part A and the part B, a terminal color change occurring within ±5 minutes of cure of said curable resin with a part B storage-separate free-radical cure initiator package including a free-radical cure initiator to form a mixture. The mixture is applied to a substrate of the marine surface in need of repair to a thickness of up to 6.35 mm. Upon curing the mixture on the substrate under conditions adapted to cause said at least one color changing dye within to change to the terminal color within ±5 minutes of cure of said curable resin to a cured condition.

A process of operating a repaired marine substrate in a water contacting environment includes the curing of a mass of unsaturated vinyl ester-having a thickness applied as a single layer to the substrate and containing from 30 to 50 mils filler. The cured mass upon being exposed to water has an absorption less than of 0.2% in freshwater or 0.15% in ocean water salinity.

A marine repair composition is provided that includes a part A and a part B. The part A includes an unsaturated vinyl ester resin, a reactive diluent, a cure promoter, a cure inhibitor, a corrosion inhibitor and a filler. The part B includes a free-radical cure initiator stored separately from the part A until mixed with the part A to form the composition.

### DETAILED DESCRIPTION OF THE PREFERRED EMBODIMENTS

The present invention has utility as a composition that cures rapidly compared to conventional compositions in marine applications, especially those for under the waterline applications. A method for curing highly filled, thick composite vinyl ester-based materials also have utility in marine repairs. To repair damage to marine vessels such as a boat, a personal watercraft, barge, ship or any form of commercial transport on water; a layer of marine filler is applied to the damaged area to a thickness of up to 250 mils (6.35 mm), cured, and shaped by sanding before applying subsequent layers. An inventive method in results in curing of thick coatings of marine fillers for under the waterline repairs. This is carried out in a shorter cure time with better sandibility, longer working time, less water and saltwater absorption, and better corrosion resistance. This filler also contains the ability to change color as the coating material is cured.

The novel feature that distinguishes current invention from prior art is the ability to cure masses with a thickness of up to 6 mm, and in some instance up to 10 mm in of 20 to 40 minutes; a shorter time compared to conventional products. The inventive composition also has desirable properties relative to the prior art, with the properties so improved including resistance to water infiltration, saltwater absorption, corrosion resistance, and a combination of any of the aforementioned.

As will be detailed below, an exemplary inventive composition performs better than conventional marine filler products in the areas of water and saltwater absorption (20% less for water and 60% less for saltwater), corrosion resistance, cure time, working time, and sandability (35% better). An inventive composition when applied using conventional application methods has a cure time that is reduced by 20 to 50% from 60 min cure times of conventional products at a like thickness. An exemplary inventive composition also has a lengthened working time of the coating this is increased by up to 40% compared to conventional marine filler products, thereby providing additional time to correct deficiencies in the applied mass before the curing begins. In addition, the color change technology adds ease of use to the product with a visual change corresponding to the progress of the cure process until a dry to sand condition has been attained. As a result, an inventive composition saves time in performing marine repairs and the resulting repair is operative for a longer duration.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, “sandable” with reference of a cured inventive formulation is defined as having limited clogging of sandpaper and able to form featheredge.

As used herein, “saltwater” as detailed herein for testing is defined as water having 3.5% salinity and a freezing point of −2° C.

As used herein, “freshwater” as detailed herein for testing is defined as distilled water having no salinity and a freezing point of 0° C.

As used herein, “terminal color change” is when an evolving color or dissipation of a color has no discernable difference in color to an unaided human eye over ten minutes under constant ambient lighting conditions.

While the present invention is detailed herein with respect to a 50:1 by weight ratio mixture of part A: part B, it is appreciated that other mix ratios are readily compounded ranging from 100-1:1±10% part A: part B without departing from the spirit of the present invention.

The present invention includes the modification of a free radical curable vinyl group resin composition to improve handling and cured mass properties in the context of marine repairs. Substrates to which an inventive formulation are applied illustratively include fiberglass, mild steel, stainless steel, zinc/zinc-aluminum-coated steel, copper, bronze, silicon bronze, tin, aluminum, solder, brass, thermoplastics, and sheet molding compositions. It is appreciated that the present invention is particularly well-suited for the marine repair industry, it also has applications in the automotive repair, architectural structure repair, and industrial equipment repair. The inventive primer formulation strongly adheres to the underlying substrate to which it is applied. Once cured and sanded, the inventive cured mass provides a surface prepared for and compatible with paint. In some inventive embodiments, the composition includes at least one dye that changes color to mark the progression of cure.

An inventive filler composition resin has a degree of ethylenic unsaturation that is between 20 and 100% of the non-alcoholic monomer in a vinyl ester-resin and denotes reactivity within the vinyl ester resin backbone to free radical polymerization. The unsaturation in a polyester backbone is reactive with vinyl and allyl moieties of a styrenic or non-styrenic molecule through free-radical polymerization. Vinyl ester resins operative herein illustratively include epoxy vinyl resin, bisphenol fumarate resin, modified bisphenol fumarate polyester resin, unsaturated polyester resin, urethane modified vinyl ester resin, urethane modified acid addition vinyl ester resin, bisphenol-epoxy vinyl ester resin, elastomer-modified vinyl ester resin, epoxy novolac vinyl ester resin, unsaturated isocyanurate vinyl ester resin, and combinations thereof. Urethane modified vinyl ester resins and urethane modified acid addition vinyl ester resins are particularly useful in the present invention as imparting fresh and salt water absorption resistance relative to other resins.

In some embodiments, an inventive primer is terminally functionalized with molecules illustratively including allyl glycidyl ether, glycidyl methacrylate, trimethylolpropane diallyl ether, allyl pentaerythritol or polymeric allyl glycidyl ether.

An inventive primer is readily formed in a single reaction or in multi-stage reactions. Typical reaction temperatures range from 130-240° C. A conventional esterification catalyst is present and illustratively includes acids, transition metal catalysts, and organo-tin compounds.

Reactive vinyl group resins used in an inventive primer composition have a weight average molecular weight ranging from 5,000 to 600,000, as determined by ASTM D4001-20. For purposes of calculating monomer percent, reactive diluents are omitted.

To form an inventive composition, the resulting reactive vinyl-ester resin is dissolved in a reactive diluent. Reactive diluents operative herein include acrylics, acrylates, and methacrylates such as methyl methacrylate, butyl acrylate, ethyl-hexyl acrylate, hydroxpropyl methacrylate, hydroxethyl methacrylate, lauryl acrylate, stearyl methacrylate, lauryl methacrylate, butanediol diacrylate, ethyleneglycol dimethacrylate, ethyleneglycol-DCPD methacrylate, ethyl(meth)acrylate and n- and isobutyl(meth)acrylate, cyclohexyl(meth)acrylate, isobornyl(meth)acrylate, benzyl(meth)acrylate, butyleneglycol dimethacrylate, diethyleneglycol dimethacrylate, triethyleneglycol dimethacrylate, propyleneglycol dimethacrylate, dipropyleneglycol dimethacrylate, tripropyleneglycol dimethacrylate and trimethylolpropane triacrylate, or DCPD diacrylate; ether monomers of the structure (C₁-C₆ alkyl)-O—(C₂-C₆ alkylene) such as ethyl vinyl ether, or methyl vinyl; styrene, α-methylstyrene, vinyl toluene, di-functional styrene, allyl substituted benzene, di-vinyl benzene, di- and trifunctional acrylates (commercially available for example as SARTOMER® and MIRAMAR® products), acrylonitrile, mono-vinyl-terminated polydimethylsiloxanes, and combinations of any of the aforementioned. It should be appreciated that a phenyl ring having two moieties in the aforementioned list is intended to include ortho isomers, para isomers, meta isomers, and isomeric mixtures of each.

The cure color change is achieved through resort to at least one color-changing dye that reacts with a free radical cure initiator during the curing process and changes color to indicate when the inventive composition has achieved a level of cure so as to be dry enough to sand. The at least one color-changing dye is added to an inventive composition during production. The compositions parts (A and B) remain storage stable until mixed with a free radical generating peroxide. The free radicals initiate a crosslinking reaction of curable resin. Dye molecules also react with free radicals and change color during that process, for instance going from red to colorless. The cure color change correlates with completion of a crosslinking reaction and indicates the time when the cured mass is ready for sanding. Dyes that are particularly useful to indicate dry to sand time exhibit one color in an oxidized state and exhibit a different color when in a reduced state. Furthermore, dyes that are particularly useful to indicate dry to sand time are those that have a reactivity with free radicals similar to reactivity of resin, typically an unsaturated polyester vinyl ester mixture. According to embodiments, the inventive composition includes a reactive dye that contains an azo group. For instance, FR-1 dye has an initially red color and after reaction becomes colorless as a result of disruption of pi bonding system being an essential part of chromophore.

Additives are present in an inventive composition to improve at least one property of handling, storage, cure rate, sandability, or substrate adhesion. The additives illustratively include at least one of a thixotropic agent, a pigment, a dye, a suppressant, a filler, an adhesion promoter, a cure inhibitor, a leveling agent, or a wetting agent.

A thixotropic agent operative in the present invention illustratively includes fumed silica, organoclays, inorganic clays and precipitated silica. Multifunctional alcohols are commonly used to enhance thixotropic properties. A thixotropic agent is present from 0 to 10 percent by weight. The thixotropic agent is typically present from 0 to 2 total weight percent of a complete composition for application to a substrate.

A fast pigment or dye operative in the present invention illustratively includes titanium dioxide, carbon black, iron oxides, and phthalocyanine blue. These fast pigments and dyes are amenable to dissolution or suspension in the reactive diluent and do not change color during the course of free radical polymerization. A pigment or dye is present from 0 to 10 total weight percent of a complete composition for application to a substrate. In some inventive embodiments, an unreactive pigment or dye, synonymously referred to herein as a fast pigment or dye is added to the part B to visually show a user when parts A and B have been uniformly mixed. In the following inventive examples, methyl ethyl ketone peroxide (MEKP) or benzoyl peroxide (BPO) are used to cure inventive compositions based on unsaturated polyester/vinyl ester mixtures.

The resin compositions of the present invention are cured to react with the reactive diluent by a number of free-radical cure initiators that include organic peroxide, azo-type initiators, electron beam, ultraviolet (UV) light, and combinations thereof. Peroxide initiators operative herein illustratively include diacylperoxides, hydroperoxides, ketone peroxides, peroxyesters, peroxyketals, dialkyl peroxides, alkyl peresters and percarbonates. Azo-type initiators operative herein illustratively include azobisisobutyronitrile (AIBN). Benzoyl peroxide (BPO) is a prototypical free-radical cure initiator. Chemical cure initiators are typically present from 1 to 5 total weight percent of a fully mixed and applied vinyl ester resin composition.

A suppressant reduces vapor emissions and in some inventive embodiments enhances surface cure time. A suppressant operative in the present invention illustratively includes waxes, polyethers, polysiloxanes and various block copolymers. A suppressant is present from 0 to 5 total weight percent of a complete composition for application to a substrate.

Filler particulates or fibers operative in the present invention illustratively include talc, alumina trihydrate, calcium sulfate, calcium carbonate, magnesium sulfate, magnesium carbonate, barium sulfate, microspheres of glass or plastics, and the like. A filler is present from 0 to 60 total weight percent of a complete composition for application to a substrate. It is appreciated that a pigment and filler can have the same function and in thoseinstances where both are present in a composition, the amounts of both are cumulative.

A leveling agent operative in the present invention illustratively includes acrylic resins, fluorocarbons, fluoropolymers and silicones. A leveling agent is present from 0 to 2 total weight percent of a complete composition for application to a substrate.

A wetting agent operative in the present invention illustratively includes boric acid esters, phosphate esters, fatty acid salts, and polyethers. A wetting agent is present from 0 to 2 total weight percent of a complete composition for application to a substrate.

An adhesion promoter operative in the present invention illustratively includes silanes, tetrahydrophthalic anhydride. An adhesion promoter is present from 0 to 2 total weight percent of a complete composition for application to a substrate.

A cure promoter is effectively a reducing agent and modulates cure kinetics. Cure promoters operative herein illustratively include dimethyl-p-toluidine, N,N-dimethylaniline, diethyl-p-toluidine, diethyl-m-toluidine, bis-propoxy-p-toluidine, N,N-diethylaniline, N-ethyl, N-hydroxy ethyl-m-toluidine, N,N-dimethyl-p-toluidine (DMPT), bis-hydroxyethyl-p-toluidine (HEPT), bis-hydroxyethyl-m-toluidine (HEMT), and combinations thereof. DMPT appears to be particularly effective in extending working time and shortening cure rate of inventive compositions relative to conventional compositions. A cure promoter is present from 0.03 to 2 total weight percent of a complete composition for application to a substrate.

A cure inhibitor is present to extend shelf storage ability and extend cure time. Cure inhibitors operative herein illustratively include hydroquinone, parabenzoquinone, toluhydroquinone, naphthoquinone, 4-tert butylcatechol, methylhydroquinone (MEHQ), tetramethylhydroquinone (TMHQ), tert-butyl catechol, metal naphthenates and combinations thereof. TMHQ appears to be particularly effective in extending working time and shortening cure rate of inventive compositions relative to conventional compositions, alone or in combination with DMPT. A cure inhibitor is present from 0.01 to 0.5 total weight percent of a complete composition for application to a substrate.

A corrosion inhibitor is added to limit substrate corrosion associated with water immersion in general, and saltwater in particular. Corrosion inhibitors operative herein include organically modified zinc aluminum molybdenum orthophosphate hydrate, zinc-5-nitroisophthalate, calcium borosilicate, a zinc salt of a benzoic acid, alkaline earth metal phosphate, zinc phosphate, zinc-barium phosphate or combinations thereof. Zinc containing phosphates are noted to be particularly effective in the present invention. A corrosion inhibitor is present from 0 to 20 total weight percent of a complete composition for application to a substrate.

A resin composition is typically stored as a part A that includes all components with the exception of a curative package, and a part B containing a curative package that is mixed with the part A immediately before application to the marine substrate. In some inventive embodiments, a resin composition is stored as a part A that includes all components with the exception of a curative package and a package containing at least one color changing dye. A part B containing a curative package, and a part C containing at least one color changing dye are mixed with part A immediately before application to the boat body substrate. It is appreciated that other components with the exception of the vinyl group resin are also present in the curative package. An inventive composition is summarized in Table 1A.

Typical component amounts for an inventive adhesive are provided in Tables 1A and 1B for parts A and B, respectively.

Tables 1A and 1B. Typical component amounts for adhesive (part A) and activator (part B), where amounts are given in weight percentages unless otherwise noted:

TABLE 1A
Resin Composition (Part-A)

| Chemical | Typical Weight % | Preferred Weight % |
|---|---|---|
| Vinyl Ester Resin | 14-70 | 22-63 |
| Reactive diluent | 0.2-10 | 0.6-4 |
| Cure Reactive Dye: FR-1 | 0.05-1.5 | 0.07-0.9 |
| 2.5 wt. % solution | | |
| Rheological: organoclay | 0-4 | 0.1-2 |
| Wetting agent: | 0-2 | 0.07-0.9 |
| alkylammonium salt of | | |
| an acidic copolymer | | |
| Cure Promoter | 0.03-2 | 0.1-1.1 |
| Adhesion Promoter | 0.1-2 | 0.1-1.1 |
| Release agent | 0.01-1 | 0.02-0.9 |
| Cure Inhibitor: reacted | 0.01-0.5 | 0.01-0.3 |
| quinone | | |
| Styrene suppressant: | 0.2-2 | 0.2-1.3 |
| wax mixture | | |
| Corrosion inhibitor | 0-20 | 3-10 |
| Fillers/pigments | Remainder | Remainder |
| | such as: | |
| Pigment: TiO₂ | 0-6.0 | 1-5 |
| Calcium carbonate: | 0-40.0 | 10-30 |
| 0.5-15 micron | | |
| Microspheres | 0-10.0 | 6-9 |
| Talc: 0.5-20 micron | 0-40.0 | 10-30 |

TABLE 1B
Curative package (Part B)

| Chemical | Typical Weight % | Preferred Weight % |
|---|---|---|
| Peroxide | 5-80 | 30-60 |
| Plasticizer (e.g non-phthalate) | 0-40 | 20-35 |
| Solvent (e.g. water) | 2-40 | 10-30 |
| Fillers | 0-remainder | 0-remainder |

The curative package in some inventive embodiments includes benzoyl peroxide-aqueous crystals. It is appreciated that the benzoyl peroxide crystals are readily with secondary solvents that solubilize the benzoyl peroxide to create a liquid part B. Partial evaporation of the liquid part B can result a benzoyl peroxide slurry. Other peroxides operative herein as curatives illustratively include tert-butyl peroxybenzoate, cumene hydroperoxide, tert-butyl hydroperoxide, and combinations thereof.

A plasticizer used herein in some embodiments is a non-phthalate. Plasticizers operative herein illustratively include benzoate ester, citrate esters, maleate esters, sulfones, naphthenic oil, phthalate and adipate esters, oligomers of polypropylene, polybutenes, polyisoprene, hydrogenated polyisoprene and polybutadiene, and vegetable and animal oils and derivatives thereof.

Fillers operative in part B are those detailed herein with respect to part A.

At dry to sand (“DTS”), the resulting mass has sufficient bond strength to the substrate to render a “featheredge,” meaning a smooth and gradual transition from primed areas to the edges primed areas, and no tearing or chipping at a perimeter edge of the cured mass on the substrate. To facilitate detection of this stage of cure, at least one dye is added that has a color change occurring at a time that corresponds to the DTS condition of the resin composition cure.

It is appreciated that because the cure of a given resin composition varies as a function of variables that illustratively include composition thickness, ambient air temperature, and cure temperature, the dye specifics as to amount and identity will have to be adjusted to coincide with the DTS condition as a function of variables such as those included in the non-exhaustive list above. Color change dyes operative herein have the attribute of a conjugated ring system having two separate aryl domains with an intermediate unsaturated bond there between of the general formula A-X-A′, where A and A′ are each independently an aryl moiety C₆H₅—, C₁₀H₇—, C₅NH₄—, C₄NH₄—, C₄N₂H₃— and substituted forms thereof in which any given hydrogen is substituted by a C₁-C₄ alkyl, C₁-C₄ alkyl primary amine, C₀-C₄ alkyl phenyl, C₀-C₄ alkyl hydroxyl, C₁-C₄ alkyl ester, C₀-C₄ alkyl sulfonates, or a combination thereof, where X is N═N, C═C, C(O), C(N—H). Without intending to be bound to a particular theory, the unsaturated central double bond is reactive with free radicals of the resin curative package and is kinetically competitive with unsaturations in the resin and monomer, such that the unsaturated central double bond reacts during cure thereby disrupting the conjugation between groups A and A′, resulting in the color created by the conjugation between A and A′ disappearing as cure progresses. It is appreciated that A and A′ may separately have a color visible, yet so long as the color of A and A′ without a pi-bonding conjugation is different than that of A-X-A′, then a suitable dye exists for the present invention. According to the present invention azo dyes are particularly suitable owing to the brilliant color of the dyes and variety of commercially available colors. With a —N═N— as the X in an inventive color changing dye, sampling various aryl groups for steric constraint of free radical reaction is a survey exercise. Specific dyes operative in the present invention include: red (FR-1 of United Initiators), those detailed in US2006/0202158, or US2016/041143; blue—(Oil Blue A of Greenville Colorants L.L.C.); and yellow/orange: dimethylamino-azobenzene (DAB), methylamino-azobenzene (MAB) aminoazobenzene (AAB), 4-hydroxyazobenzene, dimethylamino-azopyridine, and substituted forms thereof in which any given aryl-hydrogen is substituted by a C₁-C₄ alkyl, C₁-C₄ alkyl primary amine, C₀-C₄ alkyl phenyl, C₀-C₄ alkyl hydroxyl, C₁-C₄ alkyl ester, C₀-C₄ alkyl sulfonates, or a combination thereof. It is appreciated the carboxy-DABs, such as 2′- or 4′-carboxy-DABs, and the methyl esters thereof are red in color.

Overcoming the unique issues related to the above-mentioned wide-ranging repair conditions using color changing dyes that react with radicals during the marine repair process and change color to indicate dry to sand time of the cured mass. The ability to visually confirm achievement of DTS time via color change reduces technician subjectivity, increases efficiency and quality while simultaneously decreasing both priming and sanding time and cost. This use environment has proven particularly challenging owing the lack of control over cure environment and repair conditions and the demands for high throughput. The at least one color changing dye is added to inventive composition during production. The composition remains stable until mixed with the free-radical cure initiator when radicals are formed. The radicals initiate crosslinking reaction of resin (vinyl group) with monomer, typically styrene, resulting in hardened mass on the repair area. Molecules of at least one color changing dye also react with radicals and change color during the resin cure process, for instance going from red to colorless. According to some inventive embodiments, a color changing dye is present from 0.3 to 3.0 total weight percent, with only 2 to 3 weight percent of the dye being the active ingredient in N-methyl-2-pyrrolidone solution. According to embodiments, a color changing dye is present from 0.1 to 0.4 total weight percent of the active dye in a complete composition for application to a substrate with the specific amounts being informed by the following examples that illustrate the rate of color change as a function of temperature and the amount of free-radical cure initiator.

In embodiments of the inventive composition, the color changing dye is present in a specific amount being informed by the following examples that illustrate the rate of color changes as a function of temperature and the amount of free-radical cure initiator with molecules of the dye at the surface of the curing inventive composition reacting with the ambient environment. It is appreciated that the inclusion of at least two color changing dyes into the inventive composition allows for increased flexibility in matching the reactivity of the color changing dyes with free radicals that correlates with DTS time of the composition under various repair conditions. However, according to embodiments, a single dye present in the inventive composition is able to provide indication of a DTS time. Through titration of the relative amount of the color changing dye in the inventive composition, matching the reactivity of the color changing dye with free radicals that correlates with the DTS time of the repair under various repair conditions is made easier. It is appreciated that the amount of free radical initiator can also be controlled to match the reactivity of the color changing dye with free radicals that correlates with the DTS time of the repair under various conditions.

Color change of the dye occurs in some inventive embodiments with resort to an unaided, normal human eye. While the color changes of the color changing dye are readily detectable with a laboratory ultraviolet-visible (UV-VIS) spectrum spectrophotometer, this equipment is uncommon in a vehicle repair shop. However, a color change associated with cure is readily detected by collecting a digital color photograph that can be analyzed by software based on the known spectra of the fill in uncured and fully cured states containing a given color changing dye package, even if not discernable by an unaided normal human eye. The analysis software operating on a remote computer accessed via the Internet or an intranet, or a device such as a tablet or smart phone used to collect the digital photograph. It is appreciated that such software can predict cure time based on analysis of two or more photographs of the same fill that vary as a function of time.

Cure reactive color change dye provides a more accurate method to determine time to start sanding, resulting in better quality of a repaired surface, especially at the featheredge, where the applied primer thins to create a common surface plane with the surface and practically allows multiple repairs to be performed in parallel by watching color changes of each repair.

The present invention is further described with respect to the following non-limiting examples. These examples are intended to illustrate specific compositions according to the present invention and should not be construed as a limitation as to the scope of the present invention.

### Example 1

A part A and a paste part B per Table 1A and 1B preferred median component amount compositions are mixed by stirring the part A and kneading the curative part B putty before usage. The part B is hand mixed into part A at a weight ration of 1:50 until a uniform color is achieved.

### Example 2

Table 2 shows a summary of testing results between a commercially available state of the art marine filler and an inventive marine repair composition of Example 1. Working time is checked by mixing each sample of marine fillers (part A) at 50:1 ratio by weight with part B. Then, applied to steel substrates at approximately 40 mil thickness. The materials are agitated everything 15 seconds to determine when the materials were no longer spreadable. Cure rate (Sand time) is checked by mixing each sample of marine fillers (part A) at 50:1 ratio by weight with part B. Then, applied to steel substrates at approximately 40 mil thickness. After working time, the sandability is checked every 5 minutes until minimum sandpaper clog is achieved. Freshwater and saltwater absorptions are conducted according to ASTM D570. Freshwater and saltwater (ASTM D1141-98) corrosion immersion testing is conducted at 93 degrees Fahrenheit for 500 hours.

TABLE 2
Comparison of properties between commercially available Marine Filler and that of Example 1.

| | | | | | | Immersion | Immersion |
|---|---|---|---|---|---|---|---|
| | | | | | | Corrosion in | Corrosion in |
| | | | | | | freshwater - | saltwater - |
| | Working | Dry to | Sandability | Freshwater | Saltwater | Creep of | Creep of |
| | time | Sand time | Weight | absorption | absorption | corrosion | corrosion |
| | (min) | (min) | loss (wt. %) | (wt. %)* | (wt. %)* | (inches)** | (inches)** |
| Commercial | 7 | 60 | 8.69 | 0.16 | 0.09 | 0.0 | 0.18 |
| product | | | | | | | |
| Invention of | 9 | 30 | 5.47 | 5.47 | 0.15 | 0.7 | 0.80 |
| Example 1 | | | | | | | |
| % Improvement | ~30 | 50 | ~60 | 20 | 40 | ~100 | ~78 |

*measured per ASTM D570
**measured per ASTM D1141-98 @ 93° F. for 500 hours

As a person skilled in the art will recognize from the previous detailed description and from the figures and claims, modifications and changes can be made to preferred embodiments of the invention without departing from the scope of this invention defined in the following claims.

1. A process for repairing a marine surface comprising:
mixing a vinyl ester-resin formulation part A comprising: a curable unsaturated vinyl ester resin, a monomer reactive diluent in which said curable resin is dissolved or suspended, and at least one color changing dye adapted to change color upon mixing of said part A and said part B, a terminal color change occurring within ±5 minutes of cure of said curable resin; with a part B storage-separate free-radical cure initiator package comprising a free-radical cure initiator to form a mixture;
applying said mixture to a substrate of the marine surface in need of repair to a thickness of up to 6.35 mm; and
curing said mixture on said substrate under conditions adapted to cause said at least one color changing dye within to change to the terminal color within ±5 minutes of cure of said curable resin to a cured condition.

2. The process of claim 1 wherein said curing occurs within 6 to 8 minutes of forming said mixture.

3. The process of claim 1 further comprising a working time of 8 to 10 minutes prior to said curing occurring.

4. The process of claim 1 further comprising sanding said cured mixture.

5. The process of claim 4 wherein sanding occurs within 30 minutes of initiating said curing.

6. A process of operating a repaired marine substrate in a water contacting environment comprising:
curing a mass of vinyl ester-having a thickness applied as a single layer to the substrate and containing from 30 to 50 mils filler,
exposing said mass to the water, said mass has a water absorption less than of 0.2% in freshwater or 0.15% in ocean water salinity.

7. A marine repair composition comprising:
a part A comprising:
an unsaturated vinyl ester resin;
a reactive diluent;
a cure promoter;
cure inhibitor;
corrosion inhibitor; and
a filler;
a part B comprising a free-radical cure initiator stored separately from said part A until mixed with said part A to form the composition.

8. The composition of claim 7 wherein said unsaturated vinyl ester resin is a urethane modified vinyl ester resin or a urethane modified acid addition vinyl ester resin, or a combination thereof.

9. The composition of claim 7 wherein said cure promoter comprises N,N-dimethyl-p-toluidine.

10. The composition of claim 7 wherein said cure promoter comprises tetramethylhydroquinone.

11. The composition of claim 7 wherein said filler comprises at least one of calcium carbonate, microspheres, or talc.

12. The composition of claim 7 further comprising a cure reactive dye.

13. The composition of claim 7 wherein part A is mixed with part B in a weight ratio of 100-1:1±10%.

14. The composition of claim 13 wherein said weight ratio is 50:1±10%.

15. The composition of claim 7 wherein said peroxide is present in said part B as a putty further comprising a plasticizer and a part B filler.
